(19) United States
(12) Patent Application Publication
(10) Pub. No.: US 2026/0359112 A1
(43) Pub. Date: Nov. 12, 2026

(54) TASK SCHEDULING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Lidong CHEN, Shenzhen (CN); Haiwu CHEN, Shenzhen (CN); Fan YE, Shenzhen (CN); Lingcheng LI, Shenzhen (CN)

(73) Assignee: TENCENT TECHNOLOGY (SHENZHEN) COMPANY LIMITED, Shenzhen (CN)

(21) Appl. No.: 19/739,067

(22) Filed: Jul. 13, 2026

Related U.S. Application Data
(63) Continuation of application No. PCT/CN2025/080171, filed on Mar. 3, 2025.

(30) Foreign Application Priority Data
Mar. 11, 2024 (CN) 202410279265.3

(51) Int. Cl. G06F 9/48; G06F 11/07

(52) U.S. Cl. CPC G06F 9/4881; G06F 9/485; G06F 11/0772

(57) ABSTRACT

A task scheduling method includes modifying task submission information of a first computing task through a second scheduler in a process in which a first scheduler creates the first computing task, the first computing task having a first priority, sensing submission of the first computing task through the second scheduler in a process in which the first scheduler submits the first computing task based on modified task submission information, and suspending, based on the second scheduler sensing submission of the first computing task, running of a second computing task, and submitting the first computing task for running, the second computing task having a second priority, and the first priority being higher than the second priority.

### CROSS-REFERENCE TO RELATED APPLICATIONS

This application is a continuation application of International Application No. PCT/CN2025/080171 filed on Mar. 3, 2025, which claims priority to Chinese Patent Application No. 202410279265.3, filed with the China National Intellectual Property Administration on Mar. 11, 2024, the disclosures of each being incorporated by reference herein in their entireties.

### FIELD

The disclosure relates to the field of cloud servers, and in particular, to a task scheduling method and apparatus, a device, and a medium.

### BACKGROUND

A current artificial intelligence (AI) task is executed through a hardware accelerated processing unit such as a graphics processing unit (GPU) or a neural network processing unit (NPU).

In the related art, calculation time of a GPU/NPU is divided into different time slices. After different computing tasks are submitted to the GPU/NPU, a time slice-based scheduler sequentially runs the computing tasks in a submission sequence of the different computing tasks.

However, because different computing tasks have different requirements on real-time performance, the foregoing scheduling method cannot meet a requirement on a computing task having a high requirement on real-time performance, affecting quality of service of the computing task having a high requirement on real-time performance.

### SUMMARY

One or more embodiments provide a task scheduling method including: modifying task submission information of a first computing task through a second scheduler in a process in which a first scheduler creates the first computing task, the first computing task having a first priority; sensing submission of the first computing task through the second scheduler in a process in which the first scheduler submits the first computing task based on modified task submission information; and suspending, based on the second scheduler sensing submission of the first computing task, running of a second computing task, and submitting the first computing task for running, wherein the second computing task has a second priority, and the first priority is higher than the second priority.

One or more embodiments provide a task scheduling apparatus including: at least one memory configured to store program code; and at least one processor configured to read the program code and operate as instructed by the program code, the program code comprising: first scheduler code and second scheduler code, wherein the second scheduler code is configured to cause at least one of the at least one processor to: modify task submission information of a first computing task in a process in which the first scheduler code causes at least one of the at least one processor to create the first computing task, the first computing task having a first priority; sense submission of the first computing task in a process in which the first scheduler code causes at least one of the at least one processor to submit the first computing task based on modified task submission information; and suspend, based on sensing the submission of the first computing task, running of a second computing task, and submit the first computing task for running, and wherein the second computing task has a second priority, and the first priority is higher than the second priority.

One or more embodiments provide a non-transitory computer-readable storage medium, storing computer code which, when executed by at least one processor, causes the at least one processor to at least: modify task submission information of a first computing task through a second scheduler in a process in which a first scheduler creates the first computing task, the first computing task having a first priority; sense submission of the first computing task through the second scheduler in a process in which the first scheduler submits the first computing task based on modified task submission information; and suspend, based on the second scheduler sensing submission of the first computing task, running of a second computing task, and submit the first computing task for running, wherein the second computing task has a second priority, and the first priority is higher than the second priority.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a structural block diagram of a computer device according to one or more embodiments.

FIG. 2 is a flowchart of a task scheduling method according to one or more embodiments.

FIG. 3 is a schematic diagram of task submission information before modification pointing to task submission information after modification according to one or more embodiments.

FIG. 4 is a flowchart of a task scheduling method according to one or more embodiments.

FIG. 5 is a schematic architectural diagram of a cloud computing system according to one or more embodiments.

FIG. 6 is a flowchart of a priority notification method for a computing task according to one or more embodiments.

FIG. 7 is a flowchart of an information prefetching method for a computing task according to one or more embodiments.

FIG. 8 is a flowchart of a task scheduling method according to one or more embodiments.

FIG. 9 is a flowchart of a method for suspending a second-priority task according to one or more embodiments.

FIG. 10 is a flowchart of a task submission method for a native computing task according to one or more embodiments.

FIG. 11 is a flowchart of a task submission method for an online task (a high-priority task or a first-priority task) according to one or more embodiments.

FIG. 12 is a flowchart of a task submission method for an offline task (a low-priority task or a second-priority task) according to one or more embodiments.

FIG. 13 is a block diagram of a task scheduling apparatus according to one or more embodiments.

FIG. 14 is a block diagram of a computer device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Kubernetes is an open-source container orchestration engine, and is configured to automatically deploy, scale, and manage a containerized application. Kubernetes is referred to as K8s for short.

A container is a sandbox technology, and a main objective is to run an application therein, and isolate the application from the outside. In addition, the sandbox can be conveniently transferred to another host machine.

Processor: a unit that is in a computer device and that is configured to execute a computing task. The processor may include at least one of a central processing unit (CPU), an accelerated processing unit (APU), a neural processing unit (NPU), a deep learning processing unit (DPU), a floating processing unit (FPU), a holographic processing unit (HPU), an intelligence processing unit (IPU), a tensor processing unit (TPU), a vector processing unit (VPU), and an intelligent cloud accelerated processing unit.

Hardware accelerated processing unit: a processor, other than a CPU, having an accelerated computing characteristic for a specific operation type. The hardware accelerated processing unit may be at least one of the foregoing GPU, NPU, DPU, FPU, HPU, IPU, TPU, VPU, and intelligent cloud accelerated processing unit.

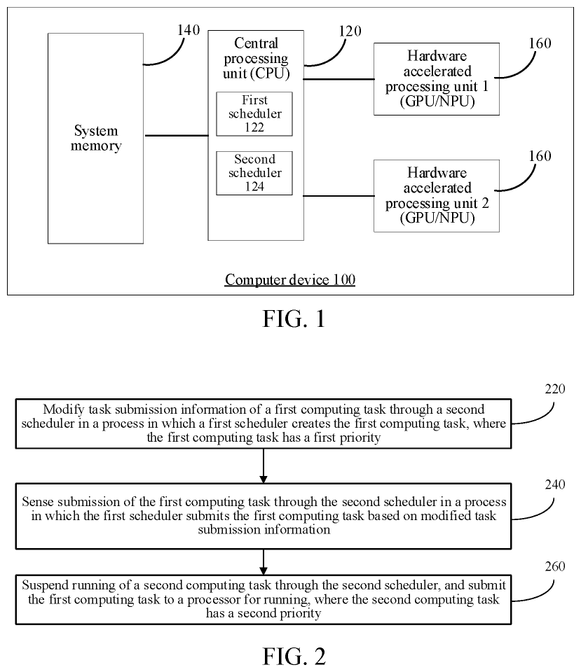

FIG. 1 is a block diagram of a computer device 100 according to one or more embodiments. The computer device 100 includes: a central processing unit 120, a system memory 140, and at least one hardware accelerated processing unit 160.

The central processing unit 120 is configured to create and schedule various computing tasks. Different computing tasks may have different priorities. A first scheduler 122 and a second scheduler 124 run in the central processing unit 120. The scheduler determines, by using different scheduling policies, which task needs to obtain a time slice of a computing resource (such as a CPU, a GPU, or an NPU) and when to obtain the time slice of the computing resource (such as the CPU, the GPU, or the NPU). The first scheduler 122 is a native task scheduler, for example, a native task scheduler provided in the K8s system. The second scheduler 124 is a user-defined task scheduler newly added. The first scheduler 122 does not have a capability of scheduling a computing task based on a priority, and the second scheduler 124 has a capability of scheduling a computing task based on a priority. In the disclosure, when an operating mechanism of the first scheduler 122 does not need to be significantly modified, the second scheduler 124 may take over a computing task submitted by the first scheduler 122 to an operating system, and the second scheduler 124 schedules computing tasks again based on priority levels. In some embodiments, an operating system is run on the computer device 100, and the operating system includes a kernel layer and an application layer. The first scheduler 122 is a scheduler located at the application layer, and the second scheduler 124 is a scheduler located at the application layer or the kernel layer.

The system memory 140 is configured to provide memory space needed in a running process of the central processing unit 120. The system memory 140 is a type of memory. The memory may further include a memory in another form such as a flash memory or a hard disk.

At least one hardware accelerated processing unit 160 is configured to run each computing task in a hardware acceleration manner. The hardware accelerated processing unit 160 may be a GPU or an NPU. The computing task may be a computing task related to artificial intelligence (AI), for example, a face recognition task or a question-answering task based on natural language processing.

The computer device 100 may be implemented as a server in cloud computing. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. A terminal may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited herein.

Some embodiments provide a task scheduling method, to schedule a plurality of computing tasks according to priority levels. When a computing task with a high priority is run, the computing task with the high priority is allowed to be run prior to a computing task with a low priority, and completely occupies a time slice; and when a computing task with a high priority is idle, a time slice is released to a computing task with a low priority, to implement hybrid deployment of computing tasks with different priorities. The computing task with the high priority may be referred to as a high-priority task for short, and the computing task with the low priority may be referred to as a low-priority task for short.

FIG. 2 is a flowchart of a task scheduling method according to one or more embodiments. The method may be performed by the central processing unit 120 in the foregoing computer device 100. For example, the method is cooperatively performed by a first scheduler and a second scheduler that are run in the central processing unit 120. The method includes the following operations.

Operation 220: Modify task submission information of the first computing task through the second scheduler in a process in which the first scheduler creates a first computing task, where the first computing task has a first priority.

The first scheduler has capabilities of creating a computing task and submitting the computing task. The capability of creating the computing task is a capability of initializing and generating a computing task. The capability of submitting the computing task is a capability of submitting the computing task to a processor for running. The processor may be the central processing unit, or may be a hardware accelerated processing unit. In this embodiment, the hardware accelerated processing unit is used as an example. In some embodiments, the first scheduler is a native scheduler of a hardware accelerated computing system. Using an example in which the hardware accelerated computing system is a K8s system, the first scheduler is a native scheduler provided by the K8s system. The first scheduler does not have a capability of scheduling computing tasks according to priority levels. In some embodiments, the first scheduler has a capability of scheduling a computing task according to a time slice.

Task submission information of the first computing task is information related to submission of the first computing task to the processor for running. In some embodiments, the task submission information of the first computing task includes address information. The address information is configured for indicating a storage location of control information configured for controlling the first computing task. In some embodiments, a device control bit of the first computing task is stored at the storage location, and the device control bit is configured for controlling start or suspension of the first computing task.

The second scheduler is a new user-defined scheduler in this embodiment. The second scheduler has a capability of scheduling computing tasks according to priority levels. In some embodiments, to avoid a case that the first scheduler directly submits the first computing task to the processor for running, the second scheduler needs to modify the task submission information of the first computing task. Modified task submission information points to a target storage location specified by the second scheduler. In some embodiments, the modified task submission information points to the target storage location that is in a system memory and that is specified by the second scheduler. In some embodiments, the device control bit of the first computing task is stored at the target storage location.

The first computing task has the first priority. The first priority is higher than a second priority. In other words, the first priority is a high priority, and the second priority is a low priority. In some embodiments, there may be more than three priorities, and the first priority and the second priority may be understood as any two of the more than three priorities.

Operation 240: Sense submission of the first computing task through the second scheduler in a process in which the first scheduler submits the first computing task based on the modified task submission information.

Because the task submission information is task submission information modified through the second scheduler, submission of the first computing task is sensed through the second scheduler in a process in which the first scheduler submits the first computing task based on the modified task submission information. In other words, the second scheduler can sense, in real time, submission of the first computing task or a submission progress of the first computing task.

Operation 260: When submission of the first computing task is sensed through the second scheduler, suspend running of the second computing task, and submit the first computing task to the processor for running, where the second computing task has the second priority.

When the second scheduler senses submission of the first computing task, running of the second computing task is suspended, and the first computing task is submitted to the processor for running.

The first computing task has the first priority, the second computing task has the second priority, and the first priority is higher than the second priority.

In conclusion, in some embodiments, because the first scheduler does not have the capability of scheduling the computing tasks based on the priority levels, the second scheduler is added based on the native first scheduler, and the second scheduler has the capability of scheduling the computing tasks based on the priority levels. When the task submission information of the first computing task does not need to be significantly modified through the native first scheduler, the task submission information of the first computing task is modified through the second scheduler, and then the first scheduler may submit the first computing task to the target storage location according to an original procedure and based on a target storage location specified by the modified task submission information. In this case, the second scheduler may sense submission of the first computing task. Then, the second scheduler takes over an actual task submission process of the first computing task, and suspends running of a second computing task with a low priority, so that running of a computing task with a high priority is preferentially performed and running of a computing task with a low priority is suspended through the second scheduler. A computing requirement of a computing task having a relatively high requirement on real-time performance can be met, quality of service of the computing task having a relatively high requirement on real-time performance can be improved, and utilization of computing resources of a computer device is significantly improved, to fully use resources and reduce resource waste.

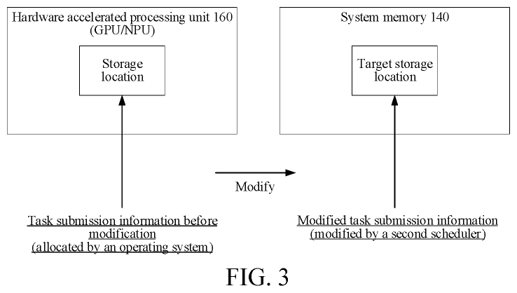

In some embodiments, with reference to FIG. 3, task submission information before modification is allocated by an operating system to the first computing task. The task submission information before modification points to a first storage location allocated by the operating system to the first computing task. For example, the first storage location is located in a hardware accelerated processing unit 160. The modified task submission information points to a target storage location specified by the second scheduler. For example, the target storage location is located in the system memory 140.

In a process in which the first scheduler submits the first computing task to the target storage location through the modified task submission information, the second scheduler may sense submission (or a submission progress) of the first computing task. In this case, running of the submitted first computing task is not triggered, and only when the second scheduler actually submits the first computing task to the processor, running of the first computing task is triggered.

In the foregoing process, the task submission information of the first computing task is modified through the second scheduler, so that the second scheduler can take over the work of the first scheduler without knowledge of the first scheduler, that is, the second scheduler can take over the work of the first scheduler without changing an operating mechanism of the first scheduler.

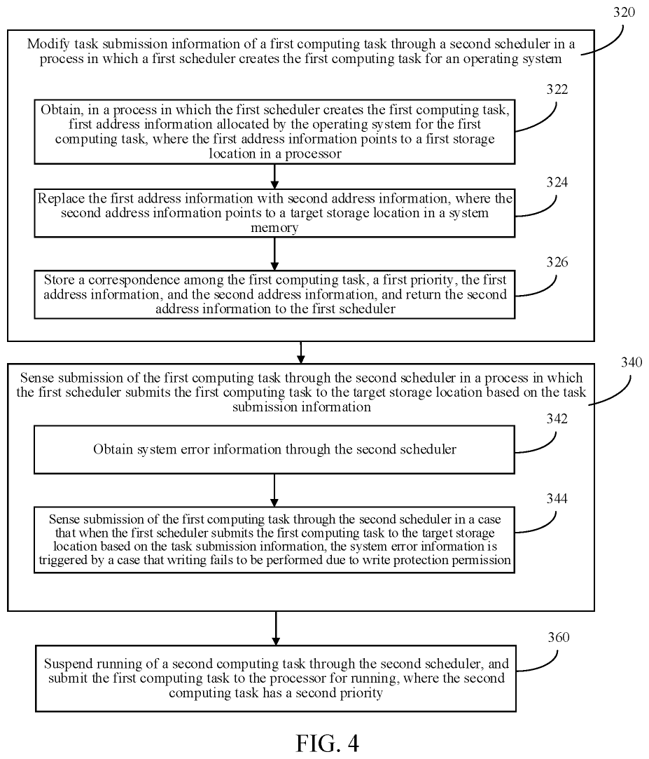

FIG. 4 is a flowchart of a task scheduling method according to one or more embodiments. The method includes the following operations.

Operation 320: Modify the task submission information of the first computing task through the second scheduler in a process in which the first scheduler creates the first computing task for the operating system.

The task submission information is information related to submission of the first computing task to the processor for running. The task submission information before modification is allocated by the operating system. In some embodiments,, the task submission information includes address information. The address information is configured for indicating a storage location of the first computing task when the first computing task is submitted. In some embodiments, the device control bit of the first computing task is stored at the storage location, and the device control bit is configured for controlling start or suspension of the first computing task. The processor may be a central processing unit, or may be a hardware accelerated processing unit. In this embodiment, an example in which the processor is the hardware accelerated processing unit is used for description.

To avoid a case that the first scheduler directly submits the first computing task to the processor for running, the task submission information of the first computing task is modified through the second scheduler. The task submission information before modification is allocated by the operating system to the first computing task. In some embodiments, the process includes the following operation 322 to operation 326.

Operation 322: In a process in which the first scheduler creates the first computing task, obtain first address information allocated by the operating system to the first computing task, where the first address information points to the first storage location in the processor.

Using an example in which the processor is the hardware accelerated processing unit, in an initialization process in which the first scheduler creates the first computing task for the operating system, a memory-mapped (mmap) technology needs to be used to obtain the first address information. The first address information is address information allocated by the operating system to the first computing task, and the first address information points to the first storage location in the hardware accelerated processing unit.

When the operating system returns the first address information to the first scheduler, the second scheduler captures the first address information. The first address information includes a first address pointer and a first address length.

Operation 324: Replace the first address information with second address information, where the second address information points to the target storage location in the system memory.

The second scheduler applies, for the first computing task, a memory page from the system memory as a masquerade memory page, where the masquerade memory page has the second address information. The second address information includes a second address pointer and a second address length. In some embodiments, the second address length is greater than or equal to the first address length.

The second scheduler replaces the first address information with the second address information.

Operation 326: Save a correspondence among the first computing task, the first priority, the first address information, and the second address information, and return the second address information to the first scheduler.

The second scheduler applies for a massive memory page, and the massive memory page is configured for masquerading as a physical page actually allocated by the operating system, so that the first scheduler writes, when submitting the first computing task, the first computing task into the masquerade memory page applied for by the second scheduler. Because the first computing task is not actually written into a real physical page, running of the first computing task is not triggered. Therefore, the second scheduler smoothly takes over work of the first scheduler without changing an operating mechanism of the first scheduler.

In some embodiments, because the priority of the first computing task is the first priority, the second scheduler further sets write protection permission for the masquerade memory page applied for the first computing task, that is, sets the write protection permission for the second address information.

When the second computing task with the second priority is created through the first scheduler, a procedure similar to operation 322 to operation 326 is also performed. In other words, in a process in which the first scheduler creates the second computing task for the operating system, the task submission information allocated by the operating system to the second computing task is modified through the second scheduler. In other words, regardless of a high-priority computing task or a low-priority computing task, actual triggering and submission are completed through the second scheduler.

In some embodiments, in the process in which the first scheduler creates the second computing task, the first scheduler may obtain third address information allocated by the operating system to the second computing task, where the third address information points to a second storage location in the (hardware accelerated) processing unit. In some embodiments, in an initialization process in which the first scheduler creates the second computing task for the operating system, an mmap technology needs to be used to obtain the third address information allocated by the operating system for the second computing task, and the third address information points to the second storage location. When the operating system returns the third address information to the first scheduler, the second scheduler captures the third address information. The third address information includes a third address pointer and a third address length. The second scheduler replaces the third address information with fourth address information. The fourth address information points to a storage location in the system memory. The second scheduler applies for a masquerade memory page from the system memory for the second computing task. The masquerade memory page has fourth address information. The fourth address information includes a fourth address pointer and a fourth address length. In some embodiments, the fourth address length is greater than or equal to the third address length. The second scheduler saves a correspondence among the second computing task, the second priority, the third address information, and the fourth address information, and returns the fourth address information to the first scheduler.

For the second computing task having the second priority, the write protection permission does not need to be set for the masquerade memory page applied for the second computing task through the second scheduler, that is, the write protection permission does not need to be set for the fourth address information.

Operation 340: Sense submission of the first computing task through the second scheduler in a process in which the first scheduler submits the first computing task to the target storage location based on the task submission information.

Because the target storage location is a storage location specified by the second scheduler, the second scheduler detects information related to the target storage location, and can sense submission of the first computing task. Sensing submission of the first computing task may be understood as: sensing submission of the first computing task by the first scheduler, or sensing a submission progress of the first computing task.

The second scheduler senses submission of the first computing task in at least three manners. In different embodiments, any one or at least one of the sensing manners may be used.

Sensing manner 1: Sensing is based on system error information, where the system error information is triggered when the first scheduler submits the first computing task to the target storage location;

Sensing manner 2: Sensing is based on the target storage location; and

Sensing manner 3: Sensing is based on a control channel, where a computing task with a first priority corresponds to a first submission channel, and a computing task with a second priority corresponds to a second submission channel.

For the sensing manner 1, the following operations may be included.

Operation 342: Obtain the system error information through the second scheduler.

The system error information generated in the operating system is detected through the second scheduler. In some embodiments, the system error information is a memory page fault.

Operation 344: Sense submission of the first computing task through the second scheduler according to the system error information in a case that when the first scheduler submits the first computing task to the target storage location based on the task submission information, the system error information is triggered by a case that writing fails to be performed due to the write protection permission.

Because the write protection permission is set for the target storage location, when the first scheduler writes information into the target storage location based on the modified task submission information, a memory page default is triggered by a case that writing fails to be performed due to the write protection permission. If the system error information detected by the second scheduler is triggered due to the foregoing reason, the second scheduler senses submission of the first computing task.

In the sensing manner 1, a memory page default mechanism of the operating system is tactfully used. The second scheduler sets the write protection permission for the second address information in advance, and then the memory page default is triggered due to the write protection permission when the first scheduler submits the first computing task, so that the second scheduler senses, in real time, an occasion at which the first scheduler submits the first computing task.

For the sensing manner 2, the second scheduler may periodically detect a state (enabled or disabled) of a device control bit that corresponds to the first computing task and that is in the target storage location. When submitting the first computing task to the target storage location, the first scheduler modifies the state of the device control bit corresponding to the first computing task into the enabled state. The enabled state represents running of the first computing task. If the second scheduler monitors a case that a value of the device control bit corresponding to the first computing task is modified into a first value, the second scheduler senses submission of the first computing task by the first scheduler to the target storage location.

For the sensing manner 3, a first submission channel (for example, a first submission function interface) may be designed for the computing task with the first priority in advance, a second submission channel (for example, a second submission function interface) may be designed for the computing task with the second priority in advance, and the second scheduler may sense submission of the first computing task by monitoring the first submission channel.

In the sensing manner 2 and the sensing manner 3, the second scheduler does not need to set the write protection permission for the target storage location to which the second address information points. If the second scheduler needs to set the write protection permission for the target storage location to which the second address information points, the first scheduler cannot write information at the target storage location.

Operation 360: Suspend running of the second computing task when the second scheduler senses submission of the first computing task, and submit the first computing task to the processor for running, where the second computing task has the second priority.

If running of at least one second computing task is not completed in this case, the second scheduler suspends running of all second computing tasks, and submits the first computing task to the processor for running. In this way, the first computing task preempts a time slice of the second computing task, so that the first computing task is preferentially run.

In some embodiments, a running mode bit (or referred to as a running state) is set in the second scheduler, and the running mode bit is configured for indicating one of a first priority mode (also referred to as a high-priority mode) or a second priority mode (also referred to as a low-priority mode). The running mode bit is set to the first priority mode when submission of the first computing task is sensed; and when duration in which running of the first computing task is completed reaches preset duration and no other computing task with the first priority (or a higher priority) is submitted within the preset duration, the running mode bit is set to the second priority mode.

The second scheduler periodically detects the running mode bit. When a current detection result in the periodic detection is that the current running mode is the first priority mode, running of the second computing task is suspended through the second scheduler, and the first computing task is submitted to the processor for running.

The first priority mode is set by the second scheduler when the second scheduler senses submission of the first computing task.

The running mode bit is set, so that real-time perception logic of the first computing task and actual submission logic of the first computing task may be decoupled, and the two logics separately run independently, to improve operational reliability of the overall logic. In addition, a period of the periodic detection may be freely configured, and may be actually changed based on a service requirement. Therefore, the period of the periodic detection has good service applicability.

In some embodiments, when the second scheduler senses submission of the first computing task, the second scheduler sets a current task mode to the first priority mode, and resets an idle timer of a task with the first priority to zero. When idle time corresponding to the idle timer of task with the first priority reaches a preset threshold, the current task mode is set to the second priority mode, where the second priority mode is configured for triggering or resuming running of the second computing task.

The preset threshold is set, so that frequent switching between the first priority mode and the second priority mode can be reduced, to prevent an offline task (a low-priority task) from being suspended again just after being resumed, wasting computing resources and increasing unnecessary time consumption.

Submission of a first computing task:

The second scheduler sets a state of the device control bit of the second computing task to the disabled state based on the task submission information of the first computing task, to enable running of the first computing task.

The second scheduler stores a correspondence among the first computing task, the first priority, the first address information, and the second address information. The second scheduler submits, based on the first address information, the first computing task to the processor for running.

In some embodiments, the second scheduler sets a state of the device control bit of the first computing task to the enabled state based on the first address information, to trigger running of the first computing task.

Because the second scheduler pre-stores the first address information allocated by the operating system to the first computing task, the second scheduler may actually submit, according to a scheduling requirement of the second scheduler, the first computing task to a GPU/NPU for running, to implement scheduling and management by the second scheduler on the task with the first priority (namely, a high-priority task).

Suspension of the second computing task:

The second scheduler sets a state of the device control bit of the second computing task to the disabled state based on the task submission information of the second computing task, to suspend running of the second computing task.

The second scheduler stores a correspondence among the second computing task, the second priority, the third address information, and the fourth address information. The second scheduler sets a state of the device control bit of the second computing task to the disabled state based on the third address information, to suspend running of the second computing task.

Because the second scheduler pre-stores the third address information allocated by the operating system to the second computing task, the second scheduler may actually suspend/start/resume the second computing task according to a scheduling requirement of the second scheduler, to implement scheduling and management by the second scheduler on a task with the second priority (namely, a low-priority task).

The disclosure can be applied to a server including a hardware accelerated processing unit, or can be applied to a containerized scenario. Different priorities are configured for different containers, so that different computing tasks (or services) in a plurality of containers are scheduled according to different priority levels. Computing tasks in a same container have a same priority.

In an exemplary application scenario, an online task is a computing task with a high priority or a first priority, and an offline task is a computing task with a low priority or a second priority. For example, an online face recognition task requires to be completed through rapid computation, and has a relatively high requirement on real-time performance. An offline content review task requires processing to be completed within two days, and has a relatively low requirement on real-time performance. A high-priority computing task generally has features such as a real-time response and a low delay. A low-priority computing task generally requires a high throughput and completion within a fixed time period.

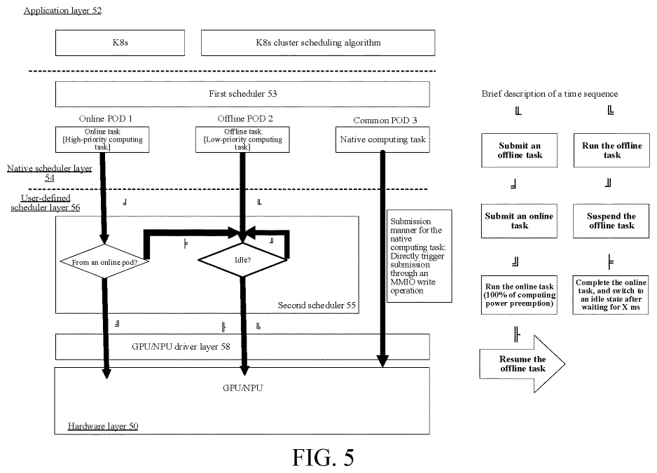

FIG. 5 is a schematic architectural diagram of a cloud computing system according to one or more embodiments. The cloud computing system includes, from a lower layer to an upper layer, an application layer 52, a native scheduler layer 54, a user-defined scheduler layer 56, a driver layer 58, and a hardware layer 50.

The application layer 52 includes: a K8s program and a K8s cluster scheduling algorithm.

The native scheduler layer 54 includes a native K8s scheduler, namely, the first scheduler 53. The first scheduler 53 can separately create a container (POD) with a high priority and a container (POD) with a low priority, computing tasks with a same priority are run in a same POD, and computing tasks with different priorities are run in different PODs. For example, the first scheduler 53 separately creates an online POD1 and an offline POD2. A computing task deployed in the online POD1 is an online task, an online computing task, a computing task with the first priority, a high-priority computing task, or the like. A computing task deployed in the offline POD2 is an offline task, an offline computing task, a computing task with the second priority, or a low-priority computing task, or the like. In some embodiments, the first scheduler 53 can further create an ordinary POD3, a native computing task in the ordinary POD is a computing task with no priority, and a submission manner for the ordinary POD3 is different from submission manners for the online POD1 and the offline POD2.

The user-defined scheduler layer 56 includes an xGPU scheduler, namely, the second scheduler 55. The second scheduler 55 is a newly added scheduler in some embodiments. Both the high-priority computing task and the low-priority computing task are submitted to the second scheduler 55 for actual trigger/submission. When the offline POD is triggered to run, the second scheduler 55 checks whether a system is currently in an idle mode (or referred to as a low-priority mode or a first priority mode). If the POD is in the idle mode, the offline POD is still submitted to a GPU/NPU for running; and if the offline task is not in the idle mode, a running offline task is suspended as required. When the online POD is triggered to run, the second scheduler 55 senses task submission of the online POD in real time, immediately suspends a running offline POD, and allocates a plurality of subsequent time slices to the online POD, until running of the online POD is completed. After running of a computing task in the online POD is completed, the second scheduler 55 circulates for x milliseconds (where x is a configurable value), and when finding that no other online POD continues to perform submission within the x milliseconds, the second scheduler 55 resumes the suspended offline POD again, to complete switching between the online POD and the offline POD.

The second scheduler 55 needs to sense a submission time point of the online POD in real time, to make a decision about a next behavior in time.

The driver layer 58 includes a driver program of the GPU/NPU.

The hardware layer 50 includes a plurality of GPUs/NPUs. FIG. 5 shows an example of one GPU/NPU. Scheduling processes of different GPUs/NPUs are the same or similar.

In a typical example, the following operations are included: operation
The first scheduler submits an offline task; operation
The second scheduler determines whether a current state is an idle mode, and if the current state is the idle mode (namely, a first priority mode or a high-priority mode), the second scheduler submits the offline task to the GPU/NPU for running; operation
The first scheduler submits the online task; and after sensing submission of the online task, the second scheduler switches the idle mode to a non-idle mode (namely, a second priority mode or a low-priority mode); operation
The second scheduler suspends the offline task; operation
The second scheduler submits the online task to the GPU/NPU for running, and in this case, may set 100% of computing power preemption for the online task; operation: Switch to the idle mode after X milliseconds after the online task is completed; and operation: Resume the offline task.

The foregoing processes are separately described below in different aspects.

Aspect 1: configuration of a high priority or a low priority for a POD/computing task.

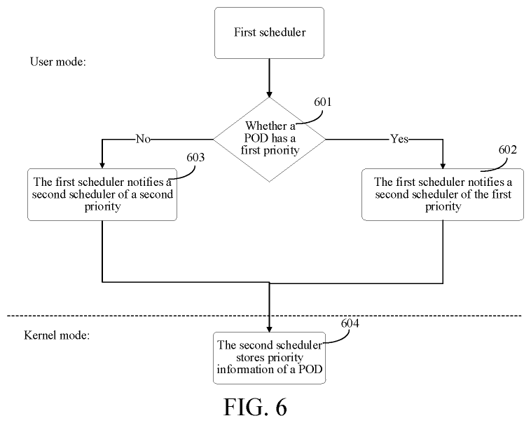

FIG. 6 is a flowchart of a priority notification method for a POD/computing task according to one or more embodiments. The method is performed by a central processing unit or a first scheduler. The method includes the following:

In a K8s scenario, a user may complete POD creation by specifying configuration information (such as a yaml file), and then start a computing task in the POD, to complete computing of the computing task.

In some embodiments, the user sets a priority flag in the configuration information, and the priority is configured for indicating a priority level of a current POD. When the priority flag is set to a first value, the priority flag is considered as a first priority flag or a high-priority flag. When the priority flag is set to a second value, the priority flag is considered as a second priority flag or a low priority flag. The first value is 1, and the second value is 0. Alternatively, the first value is 0, and the second value is 1.

Operation 601: Whether the POD has the first priority.

The first scheduler determines whether the POD has the first priority.

The first scheduler searches the configuration information for the priority flag of the POD. When the first priority flag is found, perform operation 602; and when the first priority flag is not found but the second priority flag is found, perform operation 603.

Operation 602: The first scheduler notifies the second scheduler of the first priority.

In some embodiments, the first scheduler notifies the second scheduler of the first priority in a form of an application programming interface (API). In this case, if the command “echo” is used to view a priority flag of a POD “xxx”, a value of the priority is 1, that is, echo 1>/x/xGPU/xxx/is_online.

Operation 603: The first scheduler notifies the second scheduler of the second priority.

In some embodiments, the first scheduler notifies the second scheduler of the second priority in a form of the API. In this case, if the command “echo” is used to view a priority flag of a POD “xxx”, a value of the priority is 0, that is, echo 0>/x/xGPU/xxx/is_online.

Operation 604: The second scheduler stores priority information of the POD.

In conclusion, in this embodiment, the first scheduler can learn of the priority information of the POD by setting the priority flag in the configuration information, so that the first scheduler notifies the second scheduler of the priority information of the POD, and the second scheduler can store the priority information of the POD to implement a subsequent priority scheduling process.

Aspect 2: A second scheduler pre-fetches task submission information of a computing task.

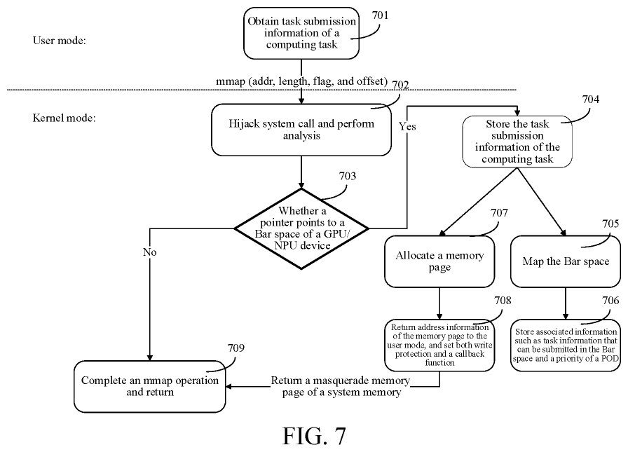

FIG. 7 is a flowchart of an information prefetching method for a computing task according to one or more embodiments. The method is performed by a first scheduler and the second scheduler. The method includes the following operations.

Operation 701: Obtain the task submission information of the computing task.

During running of a service process (a process corresponding to the computing task) in a POD, a series of system configurations are first performed. A configuration operation in the system configuration is mapping out a specific Bar space of a peripheral component interconnect (PCI) device (namely, a GPU/NPU), so that the computing task obtains a pointer and a length as the task submission information. The pointer points to a start address allocated to the computing task in the PCI device, and the length is configured for indicating an address length allocated to the computing task.

The PCI device uniformly uses an mmap technology. A service process of the first scheduler obtains the task submission information of the computing task based on mmap call. The PCI device is a hardware accelerated processing unit connected through a PCI bus.

Operation 702: Hijack system call and perform analysis.

The second scheduler hijacks the mmap system call, and analyzes mmap call result information returned by the mmap. The mmap call result information includes: a pointer (addr), a length, a device control bit (flag), and an offset value (offset) of the device control bit relative to an address to which the pointer points. The pointer points to a start location of a storage location in the GPU/NPU, and the length indicates a length of the storage location. The device control bit is stored in the storage location, and is configured for triggering start/resumption/suspension of the computing task. In this embodiment, suspension and suspension may be understood as a same meaning. “Hijacking” is a technical term in the computer field, and in the disclosure, means that the second scheduler captures and modifies the call result information returned by the mmap, so that modified call result information points to another storage location.

The mmap call result information is the task submission information of the computing task.

Operation 703: Whether the pointer points to the Bar space of the GPU/NPU.

The second scheduler determines whether the pointer in the mmap call result information points to the Bar space of the GPU/NPU.

If the pointer points to the Bar space of the GPU/NPU, perform operation 704; and if the pointer does not point to the Bar space of the GPU/NPU, perform operation 709.

Operation 704: Store the task submission information of the computing task.

The second scheduler stores the mmap call result information as the task submission information of the computing task. When the computing task needs to be submitted to the GPU/NPU for running after configuration of all computing tasks is completed, the first scheduler sets a state of a device control bit of the computing task to an enabled state based on the address information, to complete an action of triggering the GPU/NPU to execute the computing task, namely, a trigger doorbell operation on hardware. After receiving the doorbell message, the GPU/NPU executes the computing task.

Operation 705: Map the Bar space.

The second scheduler maps the Bar space of the GPU/NPU by using the pointer in the mmap call result information, to learn of task information that can be submitted in the Bar space. For example, the device control bit is configured for controlling start or suspension of the computing task.

Operation 706: Store associated information such as the task information that can be submitted in the Bar space and a priority of the POD.

The second scheduler stores, in an associated manner, associated information such as the computing task, the POD in which the computing task is located, the priority of the POD, and the pointer and the length (the first address information) of the Bar space corresponding to the computing task.

Operation 707: Allocate a memory page.

The second scheduler further allocates a memory page in a system memory, and the memory page is used as a storage location specified by the second scheduler. Address information of the memory page includes a pointer and a length, the pointer points to a start address of the memory page, and the length indicates an address length of the memory page. In some embodiments, the address length of the memory page is greater than or equal to the length returned by the mmap.

Operation 708: Return the address information of the memory page to a user mode, and set both write protection and a callback function.

The second scheduler replaces the address information (the first address information) returned by the mmap with the address information (the second address information) of the memory page, and then returns a modified mmap mapping result information to the first scheduler in the user mode.

In some embodiments, when a priority of the computing task/POD is a first priority, the write protection permission further needs to be set for the memory page, so that system error information is triggered when the first scheduler submits the computing task subsequently. A callback function further needs to be set. The callback function is configured for setting a current running mode to a high-priority mode when submission of the computing task with the first priority is sensed. When the priority of the computing task/POD is a second priority, the write protection permission and the callback function do not need to be set for the memory page.

Because the second scheduler replaces the address information returned by the operating system with the address information of the memory page of the system memory, Therefore, after the first scheduler submits the computing task based on the address information of the memory page of the system memory, the first scheduler writes only the doorbell message (a message whose device control bit is in the enabled state) into the memory page, and the GPU/NPU is not actually triggered to run the computing task.

Operation 709: Complete an mmap operation and return.

Aspect 3: task scheduling management by a second scheduler.

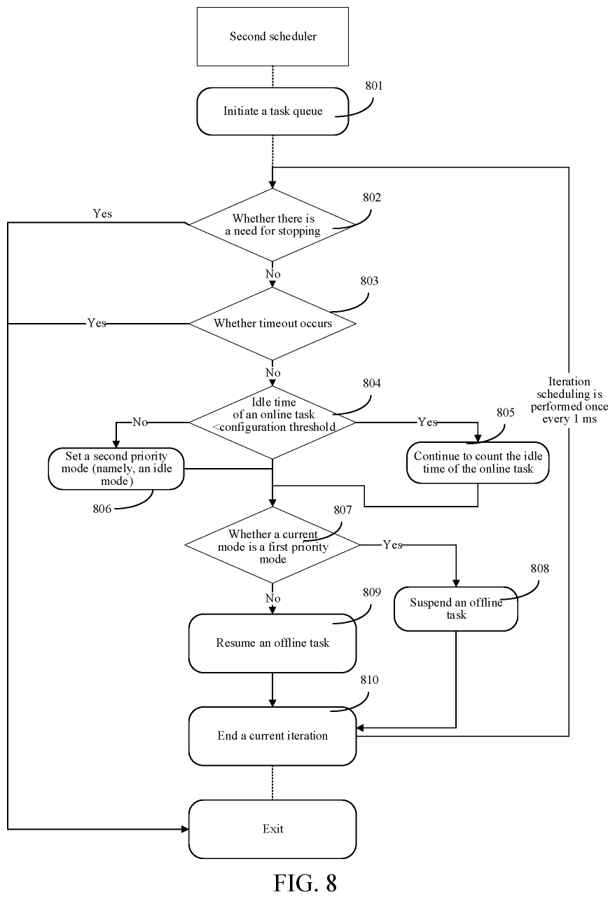

FIG. 8 is a flowchart of a task scheduling method based on a hardware accelerated processing unit according to one or more embodiments. The method is performed by the second scheduler. The method includes the following operations.

Operation 801: Initiate a task queue.

The task queue is configured for storing a computing task that has not been completely executed. One same POD includes at least one computing task. In the method shown in FIG. 7, the second scheduler can obtain the task submission information of each computing task, and initialize the task queue according to the task submission information.

When the second scheduler is loaded in a kernel mode for running, the second scheduler needs to first create a corresponding kernel thread according to a dimension of each hardware accelerated processing unit. Each hardware accelerated processing unit corresponds to a kernel thread. That is, hardware accelerated processing units and kernel threads are in one-to-one correspondence. In some embodiments, the kernel thread is a kernel kthread of a linux kernel.

Operation 802: Determine whether there is a need for stopping.

A stop condition is a parameter that needs to be set by the kernel kthread, and the stop condition is set to null in this embodiment. That is, a determining result of operation 802 is always no.

If a stop condition is met, exit; and if the stop condition is not met, perform operation 803.

Operation 803: Determine whether timeout occurs.

A timeout condition is a parameter that the kernel kthread needs to set. In this embodiment, timeout duration is set to zero. That is, a determining result of operation 803 is always no.

If the timeout occurs, exit; and if timeout does not occur, perform operation 804.

Operation 804: Determine whether idle time of an online task is less than a configuration threshold.

In this embodiment, the online task is a task with a first priority or a high-priority task. The idle time is accumulated duration after a latest online task is submitted.

If the idle time of the online task is less than a configuration threshold, perform operation 805; and if the idle time of the online task is greater than or equal to the configuration threshold, perform operation 806.

Operation 805: Continue counting the idle time of the online task.

In some embodiments, the idle time of the online task is counted by a timer. The second scheduler resets the timer when a preset condition is met. In some embodiments, the preset condition is that submission of the online task is sensed.

Operation 806: Set a current running mode to a second priority mode.

Operation 807: Determine whether the current running mode is a first priority mode.

If the current running mode is the first priority mode, perform operation 808; and if the current running mode is not the second priority mode, perform operation 809.

Operation 808: Suspend (all) offline tasks.

Pause all the offline tasks in the task queue when the current running mode is the first priority mode. In this embodiment, an example in which the computing task with the second priority is an offline task is used for description.

Operation 809: Resume the offline task.

When the current running mode is the second priority mode, one or more offline tasks in the task queue are resumed. In some embodiments, the second scheduler resumes the one or more offline tasks in the task queue according to a scheduling policy of the offline task. The scheduling policy of the offline task is not limited herein.

Operation 810: End a current iteration.

When the kernel kthread is created, duration, for example, 1 ms, for each iteration check is specified. In different embodiments, the duration may be shorter, for example, only one clock tick count (jiffy) of the kernel system. The duration may also be longer, and may be dynamically adjusted according to a service requirement.

Aspect 4: suspension of a low-priority task.

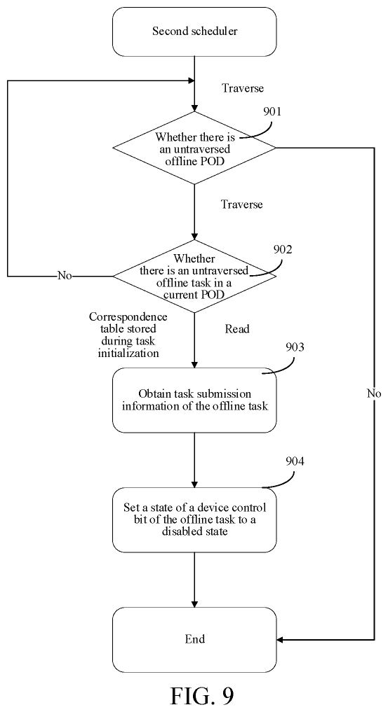

FIG. 9 is a flowchart of a suspension method for a low-priority task according to one or more embodiments. In this embodiment, an example in which the method is performed by a second scheduler, a high-priority task is an online task, and the low-priority task is an offline task is used. The method includes the following operations.

Operation 901: Determine whether there is an untraversed offline POD.

The second scheduler traverses all offline PODs. The second scheduler determines whether there is an untraversed offline POD. An offline POD includes at least one offline task. In this embodiment, the offline POD is the POD with the second priority, and the offline task is the computing task with the second priority.

If there is an untraversed offline POD, perform operation 902; and if all the offline PODs are traversed completely, exit.

Operation 902: Determine whether there is an untraversed offline task in a current POD.

The second scheduler obtains an untraversed POD as the current POD, and determines whether there is an untraversed offline task in the current POD.

If there is an untraversed offline task in the current POD, perform operation 903; and if all the offline tasks in the current POD are traversed completely, return to perform operation 901.

Operation 903: Obtain task submission information of the offline task.

In the method shown in FIG. 7, the second scheduler has pre-stored a correspondence among the offline task, the POD in which the offline task is located, a priority of the POD, third address information, and fourth address information.

The third address information points to a storage location (Bar space) in the GPU/NPU, and the fourth address information points to a storage location in the system memory.

Operation 904: Set a state of a device control bit of the offline task to a disabled state.

The second scheduler sets the state of the device control bit that is in the GPU/NPU and that is of the offline task to the disenabled state based on the third address information, to suspend the offline task.

Aspect 5: A high-priority task is run prior to a low-priority task.

When an offline task is running, if an online task is submitted to a GPU/NPU in this case, a doorbell message is triggered. In this case, a second scheduler needs to implement the following capabilities:
(1) sensing submission of the online task in real time;
(2) suspending the offline task (which is described in Aspect 4); and
(3) executing the online task.

Before a specific process in which the online task is run prior to the offline task is analyzed, refer to a task submission procedure of a native computing task in the related art.

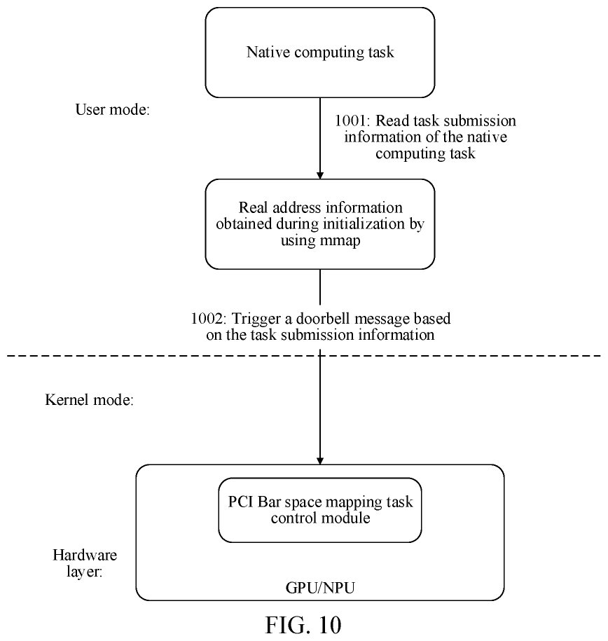

FIG. 10 is a flowchart of a task submission method for a native computing task according to one or more embodiments. The method is performed by a first scheduler, and the method includes the following operations:

Operation 1001: Read task submission information of a native computing task.

The first scheduler reads the task submission information of the native computing task, to obtain, during initialization, real address information obtained by using mmap. The real address information refers to address information in the GPU/NPU.

Operation 1002: Trigger the doorbell message based on the task submission information.

There is a device control bit of the native computing task in a storage location indicated by the real address information. When a state of the device control bit is set to an enabled state, it indicates that the native computing task is run; and when a state of the device control bit is set to the disabled state, it indicates that the native computing task is suspended.

That the state of the device control bit is set to the enabled state may be considered as triggering the doorbell message. The first scheduler sets the state of the device control bit to the enabled state through a memory mapping input/output (MMIO) write operation, to trigger the doorbell message corresponding to the native computing task.

A PCI Bar space mapping task control module exists in the GPU/NPU. After the state of the device control bit is set to the enabled state, the PCI Bar space mapping task control module runs the native computing task. The task submission process does not need participation of a driver, and therefore better performance can be achieved.

For (1) and (3), when the first scheduler submits the online task, the first scheduler performs the MMIO write operation in the same manner in FIG. 10, to trigger the doorbell message.

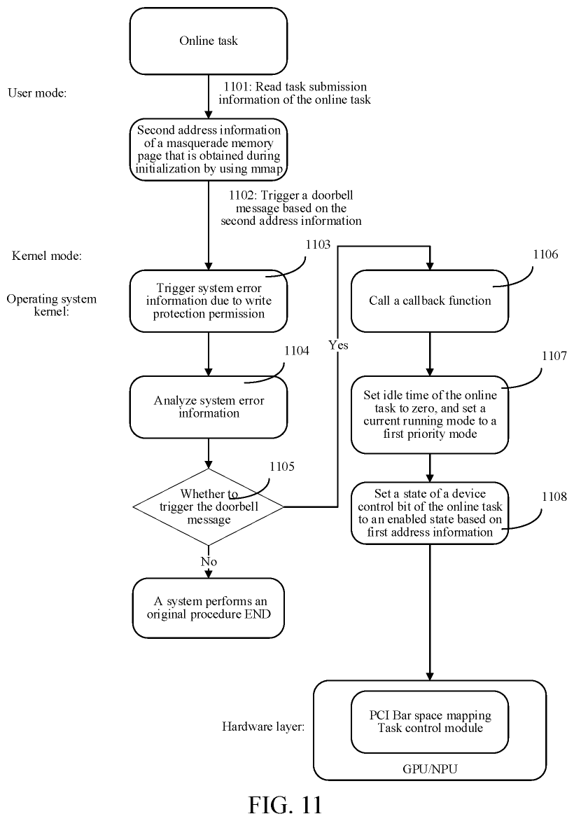

FIG. 11 is a flowchart of a task submission method for an online task (a high-priority task) according to one or more embodiments. In this embodiment, an example in which the method is performed by the first scheduler and the second scheduler, a high-priority task is the online task, and a low-priority task is the offline task is used for description. The method includes the following operations.

Operation 1101: Read task submission information of the online task.

The first scheduler reads the task submission information of the task, to obtain, during initialization, second address information of a masquerade memory page that is obtained by using mmap. The second address information is modified through the second scheduler, and the second address information points to a memory page in a system memory.

Operation 1102: Trigger a doorbell message based on the second address information.

Write protection permission is set for the masquerade memory page to which the second address information points. When the first scheduler writes the doorbell message into the second address information through an MMIO write operation, system error information is triggered by a case that writing fails to be performed due to the write protection permission.

Operation 1103: Trigger the system error information due to the write protection permission.

The system error information is memory page fault information. The memory page fault error information is triggered by a case that writing fails to be performed due to the write protection permission.

Operation 1104: Analyze the system error information.

The second scheduler monitors the system error information. After a piece of system error information is monitored, the system error information is analyzed. Using an example in which the system error information is the memory page fault information, an address into which the memory page fault information needs to be written and a type of a write instruction are learned through analysis.

Operation 1105: Whether to trigger the doorbell message;

The second scheduler determines, based on the address into which the memory page fault information needs to be written and the type of the write instruction, whether to trigger the doorbell message after the write operation is performed.

If the second scheduler is to trigger the doorbell message, perform operation 1106; and if the second scheduler is not to trigger the doorbell message, ignore the system error information, and an operating system performs an original procedure.

Operation 1106: Call a callback function.

The callback function is a callback function registered in advance by using a vma of an operating system kernel. The vma is short for a data structure (struct vm_area_struct) for managing a user space by a kernel.

The callback function is configured for setting a current running mode to a first priority mode (namely, a high-priority mode) when the second scheduler senses submission of a computing task with a first priority is submitted.

Operation 1107: Set idle time of an online task to zero, and set the current running mode to the first priority mode.

The callback function is configured for updating the current running mode of the second scheduler. The current running mode is set to the first priority mode. In addition, idle time of the task with the first priority is reset to zero, to trigger the second scheduler to perform operation 804 and subsequent operations in FIG. 8.

Operation 1108: Set a state of a device control bit of the online task to an enabled state based on first address information.

The second scheduler performs an MMIO write operation based on the first address information, and sets the state of the device control bit of the online task to the enabled state. In other words, the doorbell message of the online task is written into a real physical page of a Bar space in a GPU/NPU, to complete a doorbell trigger operation in an online task submission procedure.

A PCI Bar control mapping task control module exists in the GPU/NPU. After the state of the device control bit is set to the enabled state, the PCI Bar control mapping task control module runs the online task.

Aspect 6: submission of a low-priority task.

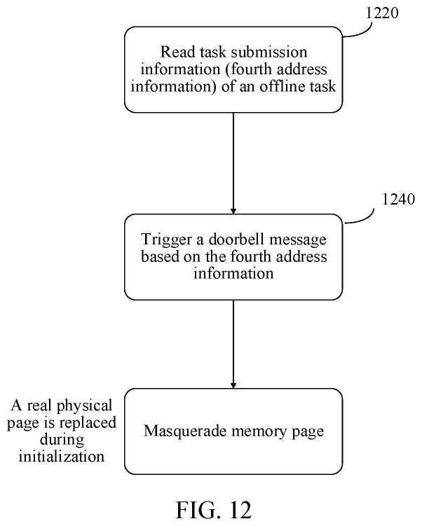

FIG. 12 is a flowchart of a task submission method for an offline task (a low-priority task) according to one or more embodiments. The method is performed by a first scheduler, and the method includes the following operations.

Operation 1220: Read task submission information of an offline task.

The first scheduler reads the task submission information of the offline computing task, to obtain, during initialization, fourth address information obtained by using mmap. The fourth address information points to a masquerade memory page in a system memory.

The first scheduler does not know a process in which the second scheduler replaces third address information with the fourth address information. Therefore, the first scheduler performs an MMIO write operation according to the fourth address information stored by the first scheduler.

Operation 1240: Trigger a doorbell message based on the fourth address information.

Because the fourth address information points to the masquerading memory page in the system memory and does not point to an actual memory page in a GPU/NPU, a real doorbell message is not triggered. The offline task is not actually submitted to the GPU/NPU for running.

Start or resumption of running of the offline task in the GPU/NPU is completed by the second scheduler based on the third address information.

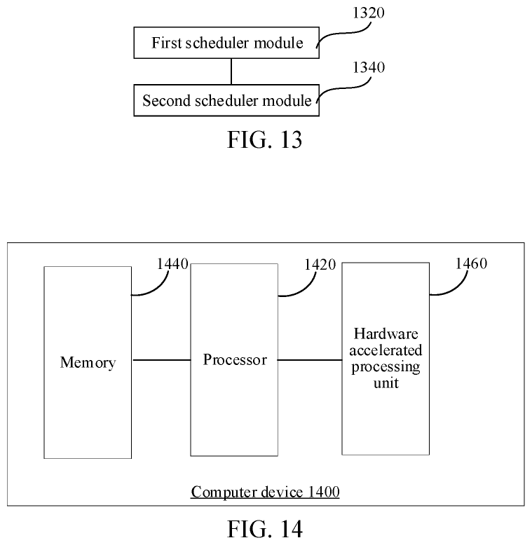

FIG. 13 is a block diagram of a task scheduling apparatus according to one or more embodiments. The apparatus includes a first scheduler module 1320 and a second scheduler module 1340.

The second scheduler module 1340 is configured to modify the task submission information of the first computing task in a process in which the first scheduler module 1320 creates the first computing task, where the first computing task has a first priority.

The second scheduler module 1340 is configured to sense submission of the first computing task, in a process in which the first scheduler module 1320 submits the first computing task based on the modified task submission information; where sensing submission of the first computing task may be understood as: sensing that the first computing task is submitted by the first scheduler module, or sensing a submission progress of the first computing task.

The second scheduler module 1340 is configured to suspend running of a second computing task, and submit the first computing task to the processor for running, where the second computing task has a second priority.

The first priority is higher than the second priority.

In some embodiments, the task submission information points to the target storage location specified by the second scheduler module 1340.

The second scheduler module 1340 is configured to sense the submission of the first computing task, in a process in which the first scheduler module 1320 submits the first computing task to the target storage location based on the task submission information.

In some embodiments, the write protection permission is set at the target storage location specified by the second scheduler module 1340.

The second scheduler module 1340 is configured to obtain the system error information; and sense submission of the first computing task in a case that when the first scheduler submits the first computing task to the target storage location based on the task submission information, the system error information is triggered by a case that writing fails to be performed when the system error information is triggered by a case that writing fails to be performed due to the write protection permission.

In some embodiments, the second scheduler module 1340 is configured to modify the task submission information of the first computing task in a process in which the first scheduler module 1320 creates the first computing task to the operating system, where the task submission information before the modification is allocated to the operating system to the first computing task.

The modified task submission information is configured to enable the first computing task to be submitted to a target storage location specified by the second scheduler module 1340.

In some embodiments, the second scheduler module 1340 is configured to: obtain first address information allocated by an operating system for the first computing task, in a process in which the first scheduler module 1320 creates the first computing task, where the first address information points to a first storage location in the processor; and replaces the first address information with second address information, the second address information points to a target storage location in the system memory; and saves a correspondence among the first computing task, the first priority, the first address information, and the second address information, and returns the second address information to the first scheduler module 1320.

In some embodiments, the second scheduler module 1340 is further configured to set the write protection permission for the second address information.

In some embodiments, the second scheduler module 1340 is further configured to: when a detection result of this time during the periodic detection is that the current running mode is the first priority mode, running of the second computing task is suspended, and the first computing task to the processor is submitted for running.

The first priority mode is set when the second scheduler module 1340 senses submission of the first computing task.

In some embodiments, the second scheduler module 1340 is further configured to: when sensing submission of the first computing task, the second scheduler module sets the current task mode to a first priority mode, and resets an idle timer of a task with the first priority to zero.

In some embodiments, the second scheduler module 1340 is further configured to: when an idle time corresponding to the idle timer of a task with the first priority reaches a preset threshold, set the current task mode to a second-priority mode, where a low-priority mode is configured for triggering or resuming running of the second computing task.

In some embodiments, the second scheduler module 1340 is further configured to set a device control bit of the second computing task to a disabled state through the second scheduler based on the task submission information of the second computing task, to suspend running of the second computing task.

In some embodiments, the second scheduler module 1340 is further configured to notify, through the first scheduler module 1320, the second scheduler module 1340 of a first priority of the first computing task and a second priority of the second computing task.

FIG. 14 is a block diagram of a computer device 1400 according to one or more embodiments. The computer device includes a processor 1420 and a memory 1440.

The memory 1440 stores at least one piece of computer readable instructions. The processor 1420 is configured to execute the at least one computer readable instruction in the memory 1440 to implement the task scheduling method according to the foregoing aspects.

In some embodiments, the processor configured to execute the computing task is the processor 1420.

In some embodiments, the computer device further includes a hardware accelerated processing unit 1460. The hardware accelerated processing unit 1460 is in connection with the processor 1420 through a PCI bus. The processor 1420 is configured to execute the foregoing task scheduling method, and the processor configured to execute the computing task is the hardware accelerated processing unit 1460.

In some embodiments, a chip is further provided. The chip includes a programmable logic circuit and/or a program instruction. When the chip runs on a computer device, the task scheduling method according to the foregoing aspect is implemented.

In some embodiments, a computer program product is further provided. The computer program product includes a computer-readable instruction, and the computer-readable instructions are stored in a non-volatile computer-readable storage medium. The processor of the computer device reads the computer-readable instruction from the computer-readable storage medium, and the processor executes the computer-readable instructions, so that the computer device performs the task scheduling method provided in the foregoing method embodiments.

In some embodiments, a non-transitory computer-readable storage medium is further provided. The computer-readable storage medium stores at least one computer-readable instruction. When the computer readable instruction is loaded and executed by a processor of a computer device, the task scheduling method provided in the foregoing method embodiments is implemented.

A person of ordinary skill in the art may understand that all or a part of the operations embodiments may be implemented by hardware or a program instructing relevant hardware. The computer-readable instructions may be stored in a computer readable storage medium. The storage medium may be a read-only memory, a magnetic disk, or an optical disc.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A task scheduling method, performed by a computer device, comprising:
modifying task submission information of a first computing task through a second scheduler in a process in which a first scheduler creates the first computing task, the first computing task having a first priority;
sensing submission of the first computing task through the second scheduler in a process in which the first scheduler submits the first computing task based on modified task submission information; and
suspending, based on the second scheduler sensing submission of the first computing task, running of a second computing task, and submitting the first computing task for running,
wherein the second computing task has a second priority, and the first priority is higher than the second priority.

2. The task scheduling method according to claim 1, wherein the task submission information points to a target storage location specified by the second scheduler; and
the sensing submission of the first computing task through the second scheduler in a process in which the first scheduler submits the first computing task based on modified task submission information, comprises:
sensing submission of the first computing task through the second scheduler in a process in which the first scheduler submits the first computing task to the target storage location based on the modified task submission information.

3. The task scheduling method according to claim 2, wherein a write protection permission is set at the target storage location specified by the second scheduler; and
the sensing submission of the first computing task through the second scheduler in a process in which the first scheduler submits the first computing task based on modified task submission information comprises:
obtaining system error information through the second scheduler; and
based on the system error information being trigged by a writing failure due to the write protection permission, sensing, through the second scheduler, submission of the first computing task according to the system error information.

4. The task scheduling method according to claim 3, wherein the modifying task submission information of the first computing task through the second scheduler in the process in which the first scheduler creates the first computing task comprises:
modifying the task submission information of the first computing task through the second scheduler in a process in which the first scheduler creates the first computing task for an operating system, the task submission information being allocated by the operating system to the first computing task; and
the modified task submission information being configured for enabling the first computing task to be submitted to the target storage location specified by the second scheduler.

5. The task scheduling method according to claim 4, wherein the modifying the task submission information of the first computing task through the second scheduler in the process in which the first scheduler creates the first computing task for the operating system comprises:
obtaining, through the second scheduler in the process in which the first scheduler creates the first computing task, first address information allocated by the operating system to the first computing task, the first address information pointing to a first storage location;
replacing the first address information with second address information through the second scheduler, the second address information pointing to the target storage location in a system memory; and
saving a correspondence among the first computing task, the first priority, the first address information, and the second address information through the second scheduler, and returning the second address information to the first scheduler.

6. The task scheduling method according to claim 5, further comprising:
setting the write protection permission for the second address information.

7. The task scheduling method according to claim 1, wherein the suspending, based on the second scheduler sensing submission of the first computing task, running of the second computing task, and submitting the first computing task for running comprises:
periodically detecting a running mode bit through the second scheduler, the running mode bit being configured for indicating one of a first priority mode and a second priority mode, and the running mode bit being set to the first priority mode based on the second scheduler sensing submission of the first computing task, and being set to the second priority mode based on a duration in which the first computing task is completely run reaching a preset duration and no computing task with the first priority being submitted within the preset duration; and
suspending, based on a current detection result in the periodic detection that a current running mode is the first priority mode, running of the second computing task through the second scheduler, and submitting the first computing task for running.

8. The task scheduling method according to claim 7, further comprising:
setting a current task mode to the first priority mode and resetting an idle timer of the computing task with the first priority to zero based on the second scheduler sensing submission of the first computing task.

9. The task scheduling method according to claim 8, further comprising:
setting the current task mode to the second priority mode based on idle time corresponding to the idle timer of the task with the first priority reaching a preset threshold, the second priority mode being configured for triggering or resuming running of the second computing task.

10. The task scheduling method according to claim 7, wherein the suspending, through the second scheduler, running of the second computing task comprises:
setting a device control bit of the second computing task to a disabled state based on task submission information of the second computing task through the second scheduler to suspend running of the second computing task.

11. The task scheduling method according to claim 1, further comprising:
notifying the second scheduler of the first priority of the first computing task and the second priority of the second computing task through the first scheduler.

12. A task scheduling apparatus, comprising
at least one memory configured to store program code; and
at least one processor configured to read the program code and operate as instructed by the program code, the program code comprising:
first scheduler code and second scheduler code,
wherein the second scheduler code is configured to cause at least one of the at least one processor to:
modify task submission information of a first computing task in a process in which the first scheduler code causes at least one of the at least one processor to create the first computing task, the first computing task having a first priority;
sense submission of the first computing task in a process in which the first scheduler code causes at least one of the at least one processor to submit the first computing task based on modified task submission information; and
suspend, based on sensing the submission of the first computing task, running of a second computing task, and submit the first computing task for running, and
wherein the second computing task has a second priority, and the first priority is higher than the second priority.

13. The task scheduling apparatus according to claim 12, wherein the task submission information points to a target storage location; and
the second scheduler code is configured to cause at least one of the at least one processor to sense submission of the first computing task in a process in which the first scheduler code causes at least one of the at least one processor to submit the first computing task to the target storage location based on the modified task submission information.

14. The task scheduling apparatus according to claim 13, wherein a write protection permission is set for the target storage location; and
the second scheduler code is configured to cause at least one of the at least one processor to obtain system error information; and sense submission of the first computing task in a case that when the first scheduler code causes at least one of the at least one processor to submit the first computing task to the target storage location based on the modified task submission information, the system error information is triggered by a case that writing fails to be performed due to the write protection permission.

15. The task scheduling apparatus according to claim 14, wherein the second scheduler code is configured to cause at least one of the at least one processor to modify the task submission information of the first computing task in a process in which the first scheduler code causes at least one of the at least one processor to create the first computing task for an operating system, the task submission information being allocated by the operating system to the first computing task; and
the modified task submission information is configured for enabling the first computing task to be submitted to a target storage location.

16. The task scheduling apparatus according to claim 15, wherein the second scheduler code is configured to cause at least one of the at least one processor to:
obtain, in a process in which the first scheduler code causes at least one of the at least one processor to create the first computing task, first address information allocated by the operating system to the first computing task, the first address information pointing to a first storage location;
replace the first address information with second address information, the second address information pointing to a target storage location in a system memory; and
save a correspondence among the first computing task, the first priority, the first address information, and the second address information, and return the second address information.

17. The task scheduling apparatus according to claim 16, wherein the second scheduler code is further configured to cause at least one of the at least one processor to set the write protection permission for the second address information.

18. A non-transitory computer-readable storage medium, storing computer code which, when executed by at least one processor, causes the at least one processor to at least:
modify task submission information of a first computing task through a second scheduler in a process in which a first scheduler creates the first computing task, the first computing task having a first priority;
sense submission of the first computing task through the second scheduler in a process in which the first scheduler submits the first computing task based on modified task submission information; and
suspend, based on the second scheduler sensing submission of the first computing task, running of a second computing task, and submit the first computing task for running,
wherein the second computing task has a second priority, and the first priority is higher than the second priority.

19. The non-transitory computer-readable storage medium according to claim 18, wherein the task submission information points to a target storage location specified by the second scheduler; and
the sense submission of the first computing task through the second scheduler in a process in which the first scheduler submits the first computing task based on modified task submission information, comprises:
sensing submission of the first computing task through the second scheduler in a process in which the first scheduler submits the first computing task to the target storage location based on the modified task submission information.

20. The non-transitory computer-readable storage medium according to claim 19, wherein a write protection permission is set at the target storage location specified by the second scheduler; and
the sense submission of the first computing task through the second scheduler in a process in which the first scheduler submits the first computing task based on modified task submission information comprises:
obtaining system error information through the second scheduler; and
based on the system error information being trigged by a writing failure due to the write protection permission, sensing, through the second scheduler, submission of the first computing task according to the system error information.
